(19) United States
(12) Patent Application Publication
(10) Pub. No.: US 2015/0196006 A1
(43) Pub. Date: Jul. 16, 2015

(54) FENCE AND TRACK APPARATUS, TRANSPORTATION SYSTEM, METHOD AND SYSTEM OF RUNNING WITH THE BULLS

(71) Applicant: Rugged Races LLC, Boston, MA (US)

(72) Inventors: Bradford D. Scudder, Boston, MA (US); Rob Dickens, Boston, MA (US)

(21) Appl. No.: 14/598,174

(22) Filed: Jan. 15, 2015

Related U.S. Application Data
(60) Provisional application No. 61/927,610, filed on Jan. 15, 2014.

(51) Int. Cl. A01K 3/00; A63K 1/00; A01K 15/02

(52) U.S. Cl. CPC A01K 3/00; A01K 15/027; A63K 1/00

(57) ABSTRACT

Disclosed herein is a bull running fence apparatus including a plurality of separate, connectable sections. The sections are connected to form a track having a first end and a second end, the sections determining a boundary of the track. The sections are further connected to form a first pen located at the first end of the track, and a second pen located at the second end of the track. The separate, connectable sections are configured to form a first stall located adjacent to the first pen and a second stall adjacent to a second pen. Further disclosed is a method of hosting a bull running event that includes providing a track having a first end and a second end opposite the first end, the track capable of containing a plurality of bulls. The method further includes allowing a plurality of participants to enter the track and initiating movement of the plurality of bulls from the first end of the track toward the second end and through the plurality of participants. A transportation system of the track on a single tractor trailer is also disclosed.

### RELATED MATTERS

This application is a nonprovisional patent application claiming priority to provisional patent application No. 61/927,610, filed Jan. 15, 2014, entitled “FENCE AND TRACK APPARATUS, TRANSPORTATION SYSTEM, METHOD AND SYSTEM OF RUNNING WITH THE BULLS” the disclosure of which being hereby incorporated by reference to the extent that it is not inconsistent with the present disclosure.

### FIELD OF THE TECHNOLOGY

The subject matter disclosed herein relates generally to fences and tracks, transportation of fences, and erection of fences. More particularly, the subject matter relates to a fence and track apparatus, transportation system thereof, and a method and system for hosting events featuring participants running on the track with live bulls.

### BACKGROUND

Many thrill-seeking individuals have an innate desire to challenge themselves physically and overcome seemingly dangerous situations. One of those situations is running with live bulls. Participants have been running with live bulls in Spain for over one hundred years. This Spanish tradition is held in the narrow streets of Pamplona. Once let loose, the bulls naturally run down the narrow streets side by side with thrill-seeking participants. This event attracts thousands of people a year. However, very few municipalities or other locations exist which would allow for this type of activity to occur in the streets. Moreover, very few streets are as narrow and closed off as the streets of Pamplona, Spain. As such, thrill seekers were generally forced to make a trip to Spain in order to experience running with live bulls.

Thus, a fence apparatus for bull running and a method of hosting a bull-running event that would easily and efficiently bring this type of event to non-urban settings throughout the world would be well received by thrill seekers looking to experience running with live bulls but who cannot or choose not to travel all the way to Spain.

### BRIEF DESCRIPTION

According to one aspect, a bull running fence apparatus comprises: a plurality of separate, connectable sections, wherein the sections are connected to form: a track having a first end and a second end, the sections determining a boundary of the track, a first pen located at the first end of the track, and a second pen located at the second end of the track; wherein the separate, connectable sections are configured to form a first stall located adjacent to the first pen and a second stall adjacent to a second pen.

According to another aspect, a method of hosting a bull running event, comprises: providing a track having a first end and a second end opposite the first end, the track capable of containing a plurality of bulls; allowing a plurality of participants to enter the track; and initiating movement of the plurality of bulls from the first end of the track toward the second end and through the plurality of participants.

According to another aspect, a transportation system comprises: a single tractor trailer including a bed configured to receive a plurality of fence sections stackable in groups, wherein the plurality of fence sections are connectable to form: a track having a first end and a second end, the sections determining a boundary of the track, a first pen located at the first end of the track, and a second pen located at the second end of the track; wherein the track is at least an eighth of a mile in length.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a schematic view of a bull running track according to one embodiment;

FIG. 2 depicts a schematic view of a bull running track of FIG. 1 in another configuration according to another embodiment;

FIG. 3 depicts a perspective view of the bull running track of FIGS. 1 and 2 configured in the manner depicted in FIG. 1;

FIG. 4 depicts a perspective view of the bull running track of FIGS. 1-3 configured in the manner depicted in FIG. 2;

FIG. 5 depicts a perspective view of a fence section of the bull running track of FIGS. 1-4 according to one embodiment;

FIG. 6 depicts a perspective view of a nook portion of the bull running track of FIGS. 1-4 according to one embodiment; and

FIG. 7 depicts a perspective view of a transportation system of the bull running track of FIGS. 1-4 according to one embodiment.

### DETAILED DESCRIPTION OF THE INVENTION

A detailed description of the hereinafter described embodiments of the disclosed apparatus and methods is presented herein by way of exemplification and not limitation with reference to the Figures.

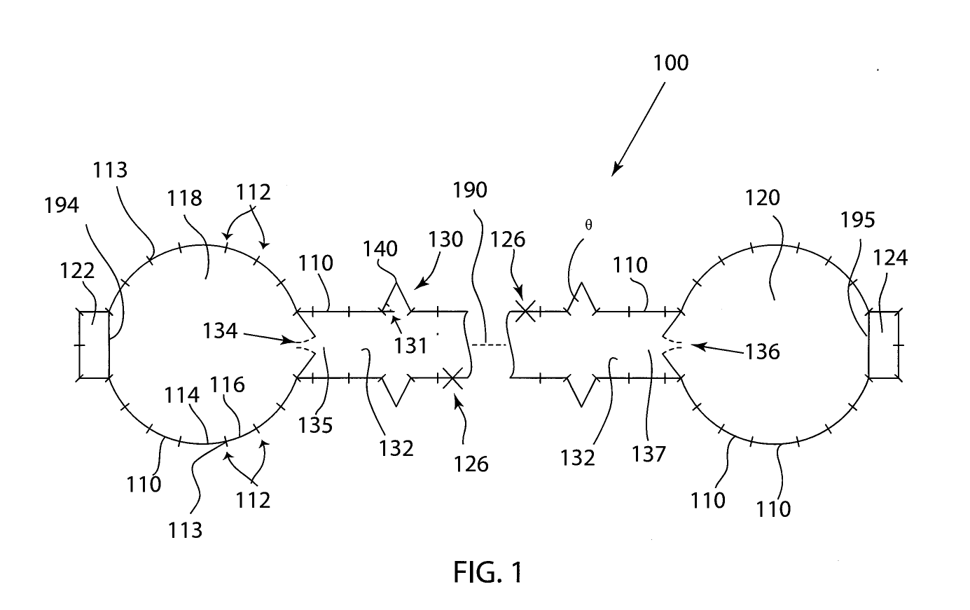

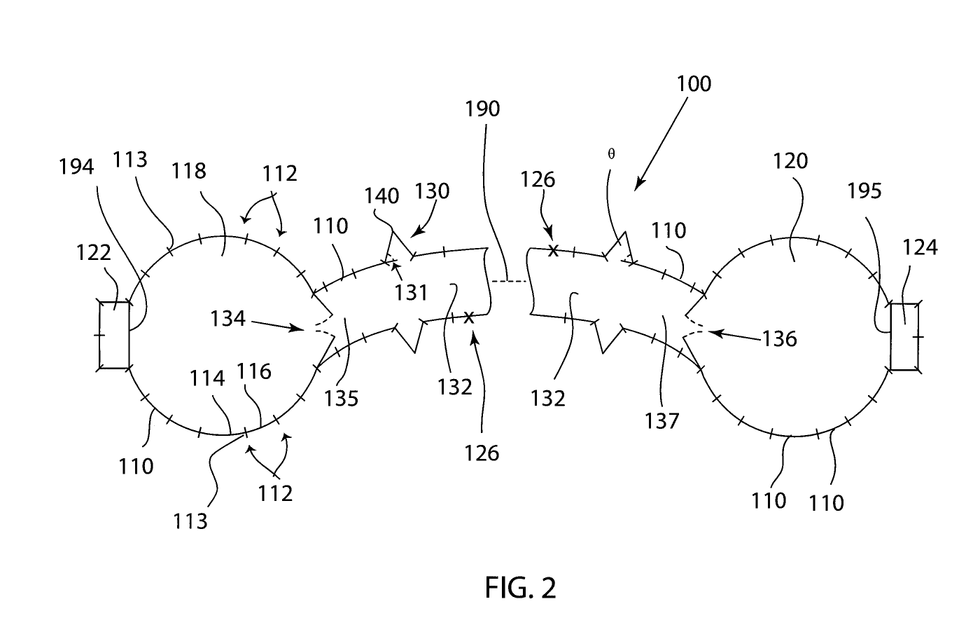

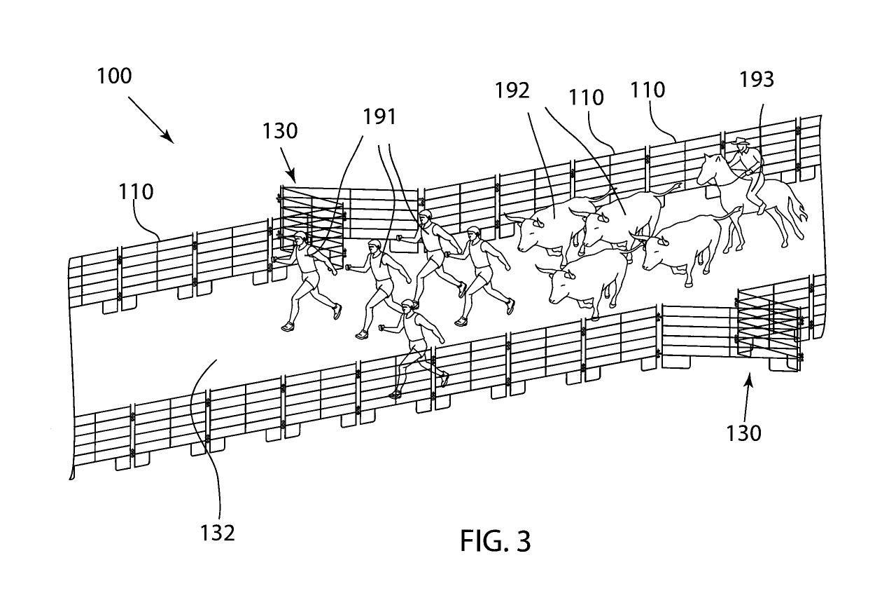

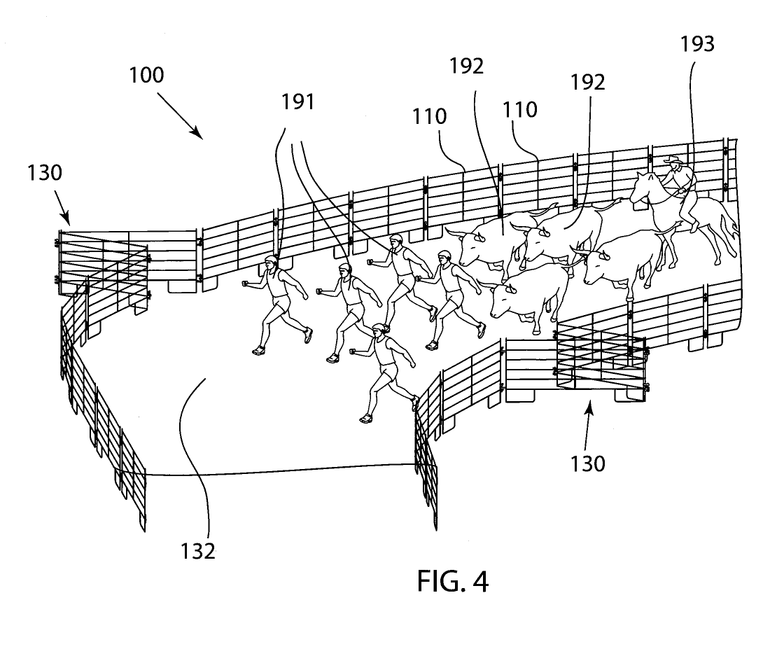

Referring firstly to FIG. 1-4, a bull-running track 100 is shown erected in two different configurations, both schematically (FIGS. 1-2) and in perspective (FIGS. 3-4). The bull-running track 100 includes a plurality of separate, connectable fence sections 110. The schematic of FIG. 1 shows each of these fence sections 110 erected, constructed or otherwise assembled to form a substantially linear bull running track 100. The schematic of FIG. 2 shows these fence sections 110 erected, constructed or otherwise assembled to form a curved track 100. It should be understood that the fence sections 110 and other components used in both configurations may be the same. The fence sections 110 may be made from metal, stainless steel, or the like. In the schematic views, hash marks 112 are shown to represent the attachment locations 113 at which point a first fence section 114 and a second fence section 116, for example, are attached. Thus, the attachment locations 113 divide the fence sections 110 in FIGS. 1 and 2. Each of the fence sections 110 are shown to be attached together to form the entirety of the bull-running track 100. The bull-running track 100 is shown to extend from at least a first pen 118 to a second pen 120. In some embodiments, as shown in FIG. 1, the bull running track 100 may be linear or substantially linear. Substantially linear may mean any arrangement which a bystander would consider to be predominantly straight or not curved, even if a precise measurement would reveal a deviation from a straight line. Alternatively, as shown in FIG. 2, there may be a slight curve to the bull running track 100; this curve may be over the length of the entire bull running track 100, or there may be a specific portion of the bull running track 100 which is curved. Thus, the bull-running track 100 may be erected in various manners and having various curves using the same fence sections 110.

The first pen 118 may include an attached first stall 122 and the second pen 120 may include an attached second stall 124. The bull running track 100 may further include a plurality of gates 126. These gates are denoted by “x” marks on the Figures, but can be provided anywhere on the track. These gates 126 may allow participants to enter or exit the bull-running track 100 without having to climb over the fence sections 110.

When connected, the fence sections 110 may form a boundary between a track area 132 and an outside area. The track area 132 may be located inside the fence sections 110 and between the first pen 118 and the second pen 120. The fence sections 110 may be connected such that this boundary is continuous and regular—that is the angle between each fence section 110 may be the same or substantially similar over the length of the track. “Substantially similar” used in this manner may mean an arrangement in which the boundary of the bull running track 100 continues in any regular or continuous way, without a sharp deviation at any point in the boundary, i.e. always having angles between fence sections 110 that are within a 1 degree deviation from an average.

The bull running track 100 may include a plurality of nooks 130 along its length. The nooks 130 may be interposed among portions of the track which have the continuous and regular boundary discussed above. The nooks 130 may be comprised of two fence sections 110 which are attached together at an apex 140 pointing away from a center 190 of the bull running track 100. The nooks 130 may create an angle θ, shown by element 131, which deviates from the otherwise identical or substantially similar angle of the line of the bull running track 100. The angle θ may be, for example, may be an offset from the angle of the fence of between 20 and 70 degrees. Other values for angle θ may be chosen if preferred for a specific track layout. In one embodiment, the angle θ may be 60 degrees.

The nooks 130 may allow participants 191 to enter in order to protect themselves as bulls 192 pass. This is because the bulls 192 have been found to naturally run down the middle of the track area 132 of the bull running track 100 and will avoid entering into the nooks 130. Moreover, the bull running track 100 may be made of multiple spans of fence sections 110 which are configured to be climbed through or over by the participants 191 in the event of an emergency, their own fear of the bulls, or other condition requiring them to vacate the track area 132. The nooks 130 may further provide structural support for the bull running track 100 against outwardly directed forces such as participants 191 or bulls 192 hitting the side walls of the bull running track 100.

In one embodiment, the first pen 118 may include both the attached first stall 122 as well as one or more additional attached stalls (not shown). The first stall 122 may be attached to the first pen 118 with a gate 195. The gate 195 may swing inward, like the gates 134, 136. Additional attached stalls (beyond the first stall 122) may be located proximate the first attached stall 122. For example, rather than the fence sections 110 located on the leftmost wall of the first attached stall 122, another stall may be attached to the first attached stall 122 with another inward swinging gate in between. Three or more stalls 122 may be located in this manner on each side of the bull running track 100. These stalls 122 may allow for a wave of bulls to be released into the first pen 118. For example, each stall 122 may house 7 bulls. Opening the first pend 122, and then each subsequent pen (without closing the others), may thereby release each wave of 7 bulls into the bull running track 100. In the same manner, the second pen 120 may include the attached second stall 124 having its own gate 195 and one or more additional attached stalls (not shown) for performing the same function. Referring to the schematics of FIGS. 1-2, if the right most stall 122 attached proximate to the first (left) pen 118 is opened allowing a first wave of bulls to enter into the first pen 118 and bull running track 100, it should be understood that this wave of bulls may end up housed in the right most stall 124 attached proximate to the second (right) pen 120. Subsequent waves would end up in corresponding stalls in this manner, ready for the next run in the opposite direction.

In operation, a plurality of participants 191 may be directed to enter into the bull running track 100 via a gate 126 positioned anywhere on the bull running track 100, such as the track area 132 or the first or second pen 118, 120. The participants 191 may then be directed into the track area 132 located between the first pen 118 and the second pen 120. The participants 191 may be directed to line up and spread themselves out at varying positions along the length of the track area 132. It should be understood that the track area 132 may be between ⅛ and ¼ of a mile in one embodiment. However, longer and shorter linear track lengths are also contemplated. Once it is determined that the participants 191 are in proper position in the track area 132, a plurality of bulls 192 may be released from the first stall 122 into the first pen 118.

The first and second pens 118, 120 may be substantially circular in shape having a diameter between 60 and 100 ft. Various other shapes and sizes may be used as desired or as is practical. For example, in other embodiments, the shape of the pens 118, 120 may be rectangular, square, or any other curved or polygonal shape. The first pen 118 may include one or more rodeo horseback riders 193 or other rodeo staff members directing the bulls 192 to and through a large gate 134, which may be located across the first pen 118 from the first stall 122. These rodeo horseback riders 193 or other staff members may thereby initiate movement of the bulls 192 from the first pen 118 toward the second pen 120. To complete this movement the bulls 192 must necessarily pass through the track area 132, and may do so at a walk or run, depending on the actions of the rodeo staff 193, the bull's temperament, and other factors.

Once the bulls 192 are directed to the gate 134, or before such a time if preferred, the gate 134 may be opened, allowing the plurality of bulls 192 to enter into the track area 132 at a first end 135 of the track area 132. The opening of this gate 134 may be done prior to release of the bulls from their respective stalls 122, 124. As shown in FIGS. 3-4, the bulls 192 may then run down the length of the track area 132. In doing so, the bulls 192 may run at a rate which exceeds the rate of speed achievable by the participants 191, thereby allowing the bulls 192 to run past the participants 191, who may avoid the bulls 192. A second gate 136 may be opened at a second end 137 of the track area 132. The bulls 192 may then naturally continue to run down the pathway provided by the bull-running track 100 and the track area 132 until they reach the second end 137 and the second opened gate 136. The bulls 192 may then enter the second pen 120. After the last bull 192 enters the second pen 120, the gate 136 may be closed, allowing the bulls 192 to again be safely maintained in a pen without being in the vicinity of the participants 191, who in at least some embodiments may not be allowed to enter the second pen 120. The bulls 192 may then be herded into the second stall 124, (and/or additional attached stalls), to wait for a future run down the bull-running track 100 in the opposite direction.

The above-described process whereby the bulls 192 begin in the first stall 122, move through the track area 132, and end in the second stall 124 may for the purposes of the present disclosure be considered a single “run.” It should be understood that the bulls 192 may be run in the opposite direction using the same principles described hereinabove. The bulls 192 may therefore run from the first pen 118 to the second pen 120 during the first run. Then, the bulls 192 may run back from the second pen 120 to the first pen 118 during the second run. This process may continue at regular or irregular intervals during a day-long or multi-day-long event. The number of bulls 192 that may participate in each run may be between 5 and 20, for example, or some other number of bulls 192 may be chosen. In one embodiment, twelve bulls may be used. The more bulls that are used, the less chance that the bulls may decide to slow down during a particular run. For example, it has been found that using the above-described structure, the use of at least twelve bulls ensures the necessary herd mentality and excitement in the bulls to prevent any slowdowns in their running. Waves are also contemplated within each run. For example, a single run may include three waves of 7-12 bulls each. Alternately, each of the bulls from all of the stalls 122, 124 from a given side may be released at the same time without waves for a large number of bulls running at a single time.

It should be understood that the position of the first stall 122 with respect to the first pen 120 may be moved to any location around the first pen 120 that is advantageous and is not limited to the embodiment shown. The first stall 122 may be a smaller size than the first pen 118. This is because the first and second pens 118, 120 may need to be large enough to slow down the charging bulls and provide enough room to disperse the herd after a run and prior to the bulls being re-herded into the stalls 122, 124 once the bulls slow down. The stalls 122, 124 may be sized as appropriate to house the calm bulls between runs. Moreover, the stalls 122, 124, may include a plurality of gated sections (not shown) which divide the stalls into a plurality of separate areas.

In one embodiment, the bull-running track 100 may form a track area 132 which may be between 24-60 feet in width to ensure enough room for the participants to avoid the charging bulls during a run. A narrower or wider distance may be used depending on the specific layout of the track, the number of bulls, the number of participants, or other factors.

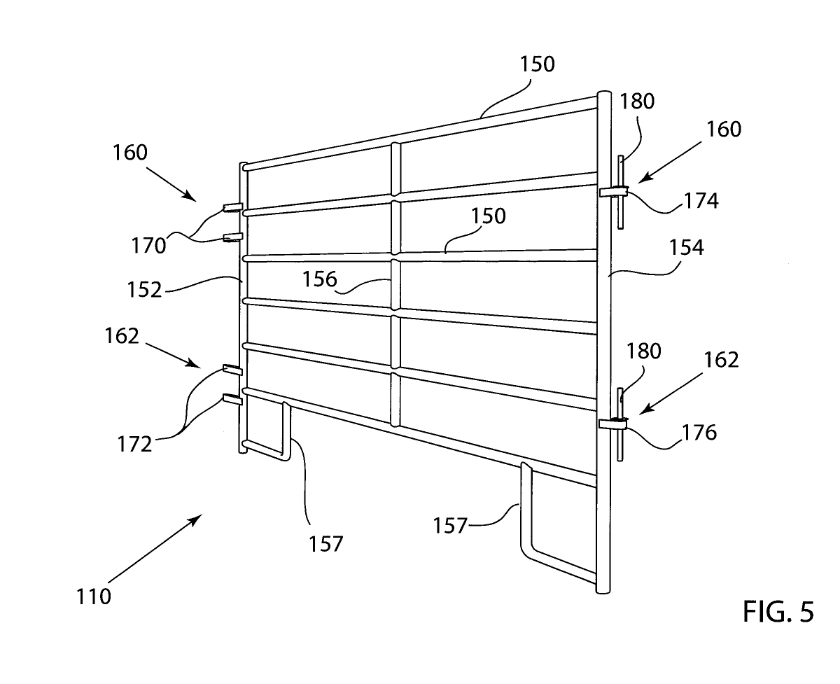

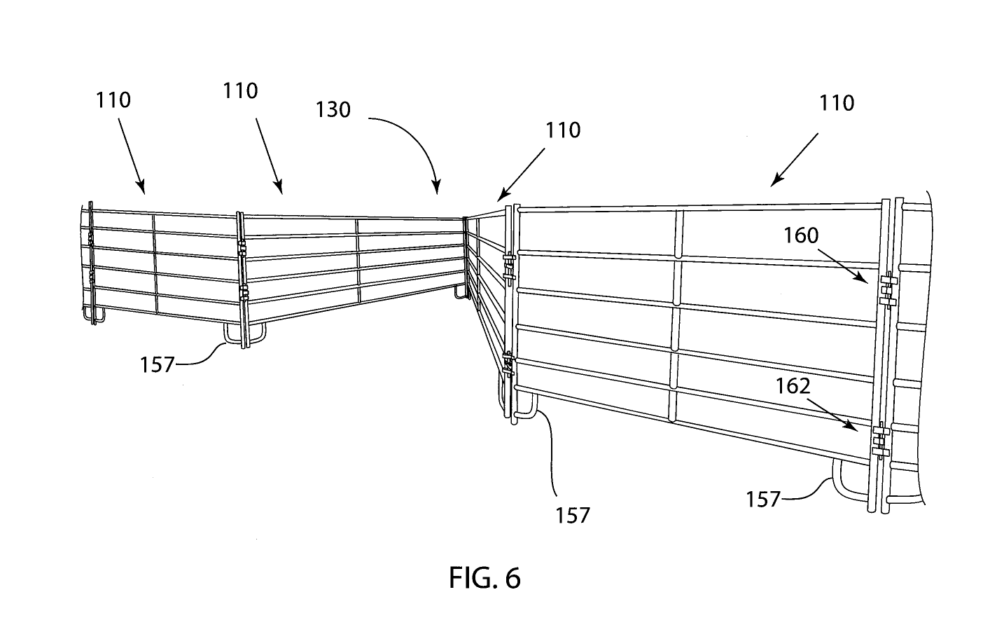

As may be seen in FIGS. 5-6, each fence section 110 may be similar or the same as other fence sections 110. In one embodiment, a substantial number of the fence sections 110 may be functionally identical. Functionally identical may mean that a functionally identical section may be replaced or interchanged with any other functionally identical section. A substantial amount of functionally identical fence sections may mean that a majority of the fence sections are functionally identical. In further embodiments, 90% or more of the fence sections 110 may be functionally identical. In one embodiment, each fence section 110 may have a length of 12 feet. In other embodiments, the length of each fence section 110 may be greater or less than 12 feet. The fence sections 110 may include a plurality of horizontal rails 150. The horizontal rails 150 may be spaced apart to ensure that a person can climb therethrough. Alternately, the horizontal rails 150 may, in combination, form a ladder over which participants can easily climb to escape the bull running track 100 or the track area 132 if necessary. The embodiment shown includes six horizontal rails 150 extending between a vertical left end rail 152 and a vertical right end rail 154. The vertical left end and right end rails 152, 154 may be dug, cemented, or otherwise secured into the ground for stability of the track. Moreover, the fence sections 110 may include a stabilizing rod 157 which extends horizontally from a bottom location of the vertical left end and right end rails 152, 154, and then curve vertically for attachment to the bottom-most horizontal rail 150. This may provide stability and support for the bottom of the fence section 110 and may ensure that the vertical left end and right end rails 152, 154 are installed in the ground at the same respective heights. The spacing between the horizontal rails 150 in the embodiment shown is between 8 and 12 inches. Thus, fence sections 110 may be at least four feet in height. However, this spacing may be increased or decreased. A middle vertical rail 156 is also provided half way between the left and right end rails 152, 154 for added stability in the fence section system.

Referring specifically to FIGS. 5 and 6, the fence sections 110 may include combined upper and lower attachment mechanisms 160, 162 attached to each of the left and right end rails 152, 154. The fence sections 110 may each include an upper left side attachment mechanism 170 and a lower left side attachment mechanism 172 each attached to the left vertical rail 152. Likewise, the fence sections 110 may each include an upper right side attachment mechanism 174 and a lower right side attachment mechanism 176 each attached to the right vertical rail 154. The upper right side attachment mechanism 174 and the lower right side attachment mechanism 176 may each include a single U-shaped projection extending from the right vertical end rail 154. The upper left side attachment mechanism 170 and the lower left side attachment mechanism 172 may each include two U-shaped projections extending from the left vertical end rail 152. The U-shaped projection of the upper and lower right side attachment mechanisms 174 and 176 of one fence section may be insertable between the two U-shaped projections of the upper and lower left side attachment mechanisms 170 and 172, respectively, of another fence section to form each of the upper and lower attachment mechanisms 160 and 162. Once the three U-shaped projections of each of the upper and lower attachment mechanisms 160 and 162 are aligned, an elongated bolt 180 may be insertable through each to attach the two fence sections 110 together. The U-shaped projections may be fashioned such that the fence sections 110 may be attachable at any angle with respect to each other. It should be understood that other attachment mechanisms are also contemplated which could attach the fence sections 110 in a similar manner.

With reference again to FIGS. 1-2, the length of the track area 132 may include a plurality of gates 126, denoted by “x” marks. The gates 126 may be dispersed at regular intervals along the track area 132 and may allow for emergency evacuation and entering for event organizers, construction crews, emergency personnel, and the like. The gates 126 may be manned with security staff during each run to prevent spectators from entering the track area 132.

The track 100 may further be erected next to or adjacent to a drag strip (not shown) so that the bull running track 100 is between the drag strip and a set of bleachers (not shown). The drag strip may be a particularly advantageous location for erecting the fence sections and hosting a bull run because it provides an elongated length of track, and enough room for both spectators and participants. However, alternate possible locations for erecting the track 100 may include a motorcross track, or any other private or public land having a length suitable for a track or for the running of a plurality of bulls.

In some embodiments, several runs may be performed in a single day. For example, in one embodiment, five to ten runs may be performed in a single day. Any other number of runs may be performed as desired. Enough bulls may be provided such that each individual bull may be only required to run in one or two of the runs. Moreover, the bull running track 100 may be erected above ground that is covered with either dirt or grass, rather than asphalt, pavement, bricks, or the like. This may protect the safety of the bulls and the participants during the event.

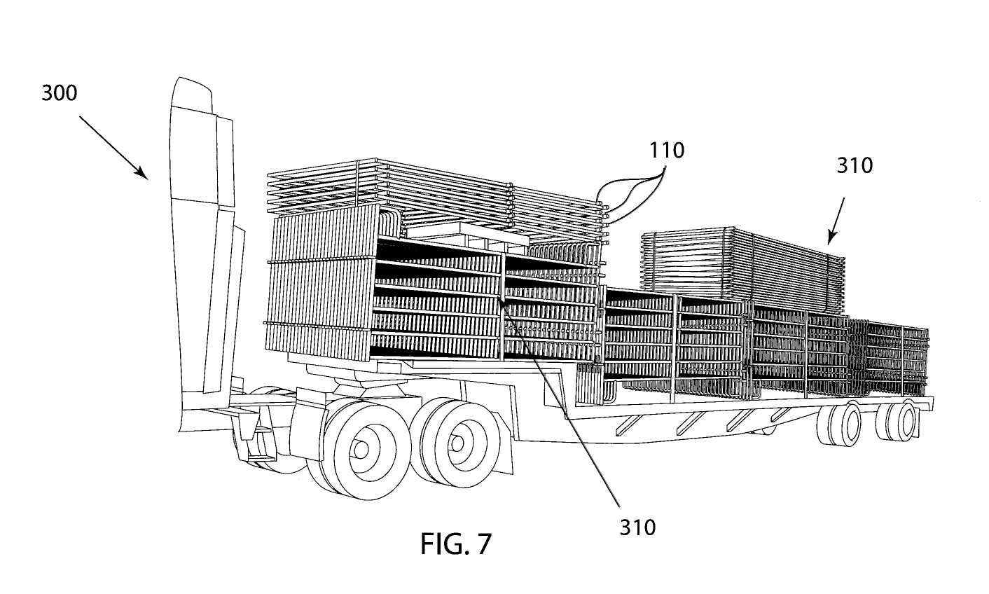

In one embodiment, as shown in FIG. 7, a transportation system is shown. In this embodiment, the entirety of the structural elements of the bull-running track 100 may be transportable behind one or more tractor trailers 300 having a bed. As shown, the fence sections 110 may be stacked into large groups 310 of twenty or more fence sections 110. Such stacking may be accomplished by an alternating offset orientation of the sections 110 on one another. For instance, a first section may be placed in a position to state a group. A second section may be placed on the first section such that their profiles overlap, or the second section may be placed on the first section a few inches inside of or outside of the area of the first section to facilitate space-efficient stacking. These groups 310 may be picked up using the hydraulic arms of a skid steer machine (not shown) to carry for distribution and erection of the track 100. A group 310 of twenty fence sections 110, for example, is shown attached along a width of the tractor trailer 300. Four such groups 310 are distributed along the length of the tractor trailer. Groups 310 of twenty fence sections 110 are shown stacked on top of the bottom groups 310. The top groups 310 are shown being rotated 90 degrees horizontally with respect to the bottom groups 310. In other words, the top groups 310 may be transported on their side, while the bottom groups 310 are shown upright.

It has been found that a length of track having two end points is particularly advantageous for bull runs (instead of, for example, circuitous tracks) for several reasons. First, a lengthwise track may allow for more spectators to attend in pre-erected grandstand structures. Moreover, an end-to-end track may require less space than a circuitous track. Still further, an end to end track may be erected between a grandstand and a drag strip. This may be particularly advantageous because a drag strip may provide for easy access for emergency vehicles such as paramedics and ambulances. Moreover, the bulls are only required to run in a relatively straight line, unlike a circuitous track where the bulls must also be making a turn during the run to get around the circuit, potentially slowing the bull down and causing additional complications for the bulls to navigate through while also trying to avoid running over participants.

However, it is contemplated that the fencing structure described herein with respect to the bull running track 100 and the fence sections 110 may be utilized on an erectable circuitous or circular track. For example, a length of track may be bent to form a curve, or the entire track may from a circle or other shape. A single pen, such as the pen 118, may be located at one point in the circuitous track. Referencing broadly the schematic shown in FIG. 1, a circuitous track may include track extending to both the right and left of the single pen 118. The stalls 122, 124 may be located above or below the pen, either inside or outside of the circuit. Gates may be included to separately open the track extending from the left side and the right side. Further, a third gate may be included either above or below the pen to open to the one or more stalls.

Embodiments disclosed herein, therefore, include erecting a track, such as the bull-running track 100. Moreover, embodiments may include deconstructing the bull running track 100 and transporting the bull running track 100 to another location. Still further, embodiments may include hosting a bull running event using the bull running track 100 as described herein.

In yet another embodiment, a method of hosting a bull running event includes providing a track having a first end and a second end opposite the first end, the track capable of containing a plurality of bulls, allowing a plurality of participants to enter the track, and initiating movement of the plurality of bulls from the first end of the track toward the second end and through the plurality of participants. The step of initiating movement of the plurality of bulls from the first end of the track toward the second end is followed by the step of initiating movement of the plurality of bulls from the second end of the track back toward the first end and through the plurality of participants. The method may further include providing a plurality of nooks along the track. The track may be structured so that a participant may climb through and over the track in order to escape from the plurality of bulls. The method may further include initiating movement of the plurality of bulls from the first end of the track toward the second end in one or more waves, each wave including a portion of the plurality of bulls. The method may further include providing a first stall located adjacent to the first pen, a second stall located adjacent to the first stall, and a third stall located adjacent to the second stall, providing a portion of the plurality of bulls in each of the first, second, and third stalls, and releasing the plurality of bulls from the stalls. The method may further include releasing the plurality of bulls from the stalls by releasing the plurality of bulls from each of the first, second, and third stalls simultaneously. The method may still further include releasing the plurality of bulls from the stalls by initially releasing only the bulls from the first stall, followed by releasing the bulls from the second stall, and then releasing the bulls from the third stall. The method may further include disassembling the track; transporting the track to another location; and re-erecting the track.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the following claims.

What is claimed is:

1. A bull running fence apparatus, comprising:
a plurality of separate, connectable sections, wherein the sections are connected to form:
a track having a first end and a second end, the sections determining a boundary of the track,
a first pen located at the first end of the track, and
a second pen located at the second end of the track;
wherein the separate, connectable sections are configured to form a first stall located adjacent to the first pen and a second stall adjacent to a second pen.

2. The bull running fence apparatus of claim 1, wherein the track is at least one of substantially linear and linear.

3. The bull running fence apparatus of claim 1, wherein the boundary of the track includes a plurality of nooks, the plurality of nooks extending the boundary of the track outward in a direction that is distal to a center of the track, the center being a middle axis located between the boundary of the track formed by the plurality of separate connectable sections.

4. The bull running fence apparatus of claim 1, wherein the first pen is separated from the track area by a first gate, and the second pen is separated from the track by a second gate.

5. The bull running fence apparatus of claim 4, wherein the first gate swings toward the track to open and wherein the second gate swings towards the track to open.

6. The bull running fence apparatus of claim 1, wherein the separate, connectable sections are configured to form a third stall connected to the first stall.

7. The bull running fence apparatus of claim 6, wherein the first and third stall are connected in series such that the connection between the first and third stall is located opposite the connection between the first pen and the first stall.

8. The bull running fence apparatus of claim 6, wherein the separate, connectable sections are configured to form a fourth stall connected to at least one of the second stall and the third stall.

9. The bull running fence apparatus of claim 1, wherein the plurality of separate, connectable sections are stackable for storage and transportation on a tractor trailer.

10. The bull running fence apparatus of claim 1, wherein at least a substantial number of the plurality of separate, connectable sections are structurally identical.

11. A method of hosting a bull running event, comprising:
providing a track having a first end and a second end opposite the first end, the track capable of containing a plurality of bulls;
allowing a plurality of participants to enter the track; and
initiating movement of the plurality of bulls from the first end of the track toward the second end and through the plurality of participants.

12. The method of claim 11, wherein the step of initiating movement of the plurality of bulls from the first end of the track toward the second end is followed by the step of initiating movement of the plurality of bulls from the second end of the track back toward the first end and through the plurality of participants.

13. The method of claim 11, further comprising:
providing a plurality of nooks along the track.

14. The method of claim 11, wherein the track is structured so that a participant may climb through and over the track in order to escape from the plurality of bulls.

15. The method of claim 11, further comprising:
initiating movement of the plurality of bulls from the first end of the track toward the second end in one or more waves, each wave comprising a portion of the plurality of bulls.

16. The method of claim 11, further comprising:
providing a first stall located adjacent to the first pen, a second stall located adjacent to the first stall, and a third stall located adjacent to the second stall;
providing a portion of the plurality of bulls in each of the first, second, and third stalls;
releasing the plurality of bulls from the stalls.

17. The method of claim 16, further comprising:
releasing the plurality of bulls from the stalls by releasing the plurality of bulls from each of the first, second, and third stalls simultaneously.

18. The method of claim 16, further comprising:
releasing the plurality of bulls from the stalls by initially releasing only the bulls from the first stall, followed by releasing the bulls from the second stall, and then releasing the bulls from the third stall.

19. The method of claim 11, further comprising:
disassembling the track;
transporting the track to another location; and
re-erecting the track.

20. A transportation system comprising:
a single tractor trailer including a bed configured to receive a plurality of fence sections stackable in groups, wherein the plurality of fence sections are connectable to form:
a track having a first end and a second end, the sections determining a boundary of the track,
a first pen located at the first end of the track, and
a second pen located at the second end of the track;
wherein the track is at least an eighth of a mile in length.
